(19) United States
(12) Patent Application Publication
(10) Pub. No.: US 2021/0268833 A1
(43) Pub. Date: Sep. 2, 2021

(54) RIM PROTECTOR

(71) Applicant: Kore Designs Inc., Brampton (CA)

(72) Inventor: William Trent Coleman, Woodbridge (CA)

(21) Appl. No.: 17/186,673

(22) Filed: Feb. 26, 2021

Related U.S. Application Data
(60) Provisional application No. 62/982,761, filed on Feb. 28, 2020.

(51) Int. Cl. B60B 7/01; B60B 7/06

(52) U.S. Cl. CPC B60B 7/01; B60Y 2200/11; B60B 2900/212; B60B 7/063

(57) ABSTRACT

The present specification relates generally to protective wheel accessories, and specifically to an improved apparatus for protecting a rim of a wheel of a vehicle. The rim protector includes a flexible strip with a rim protector portion, which is disposed along a length of the flexible strip and is configured to be seatable on and abut an outer surface of a circumference of a rim of a wheel. Opposite the rim protector portion, the flexible strip has an insertion edge, which is insertable between the rim of the wheel and a tire. The rim protector also includes a fastening mechanism, which allows the flexible strip to be securable in a substantially circular configuration, and at least one set of teeth disposed along a longitudinal axis of the flexible strip. A related method of installing a rim protector for a rim of a wheel of a vehicle is also described.

### FIELD OF THE INVENTION

The present specification relates generally to protective wheel accessories, and specifically to an improved apparatus for protecting a rim of a wheel of a vehicle.

### BACKGROUND OF THE INVENTION

Wheel rims, commonly referred to as rims, provide structural support for tires used in association with wheeled vehicles, such as automobiles, all-terrain vehicles (ATVs) and bicycles. Metals are often used to manufacture rims and, commonly, metal alloys are used as they are typically lighter and provide good strength. Use of metal alloys rims may provide performance advantages due to their lighter composition; however, they are also prone to damage, especially in comparison to steel rims.

Typically, rims may experience damage due to poor road conditions and impact with roadside objects, such as curbs. The extent of rim damage can range from unsightly scratches to, in more severe circumstances, a bent, dented or cracked rim, which renders a rim unusable.

Repairing alloy rims can be expensive and time consuming. Accordingly, in an effort to protect rims, coatings are sometimes applied to rims for an extra layer of protection. However, protective coatings typically wear off after a few years and, even when newly applied, protective coatings do not significantly increase the strength of the metal. Other known preventative measures include installing a protective layer between a rim and a tire, in order to create a barrier that absorbs impact from curbs, potholes and other poor road conditions.

For example, U.S. Pat. Nos. 8,807,664 and 9,370,966 describe a device for installation between a rim of a wheel of a vehicle and a tire. These disclosed devices, however, leave a gap between the rim and the protective layer, which allows dirt and brake dust to accumulate in the gap, and require clips and glue to perform the installation, which makes removal and reinstallation of the protective layer difficult, respectively.

Accordingly, there remains a need for improvements in the art.

### SUMMARY OF THE INVENTION

In an embodiment of the present invention, there is provided a rim protector for a rim of a wheel of a vehicle, the rim protector comprising: a flexible strip comprising, a first strip end, a second strip end, a rim protector portion, an insertion edge, a fastening mechanism and at least one set of teeth; the rim protector portion disposed along a length of the flexible strip between the first strip end and the second strip end and is configured to be seatable on and abut an outer surface of a circumference of a rim of a wheel of a vehicle; the insertion edge disposed along a length of the flexible strip, opposite the rim protector portion, between the first strip end and the second strip end and is configured to be insertable between the rim of the wheel of the vehicle and a tire; the fastening mechanism configured to fasten the first strip end to the second strip end such that the flexible strip is securable in a substantially circular configuration; and the least one set of teeth disposed along a longitudinal axis of the flexible strip and configured to anchor the insertion edge between the rim of the wheel of the vehicle and the tire.

In an embodiment of the present invention, there is provided a method of installing a rim protector for a rim of a wheel of a vehicle, the method comprising: partially deflating a tire disposed about a rim of a wheel of a vehicle; placing an insertion edge disposed along a length of a flexible strip between the rim of the wheel of the vehicle and a tire; cutting the flexible strip to a length that substantially corresponds to a circumference of the wheel rim; and applying force to a rim protector portion disposed along a length of the flexible strip opposite the insertion edge to seat the rim protector portion on the circumference of the rim of the wheel of the vehicle.

Other aspects and features according to the present application will become apparent to those ordinarily skilled in the art upon review of the following description of embodiments of the invention in conjunction with the accompanying figures.

### BRIEF DESCRIPTION OF THE DRAWINGS

The principles of the invention may better be understood with reference to the accompanying figures provided by way of illustration of an exemplary embodiment, or embodiments, incorporating principles and aspects of the present invention, and in which:

FIG. 1 is a front view of an improved rim protector, according to an embodiment;

FIG. 2 is a back view of the improved rim protector of FIG. 1;

FIG. 3 is a top side view of the improved rim protector of FIG. 1;

FIG. 4 is an underside view of the improved rim protector of FIG. 1;

FIG. 5 is an underside view an improved rim protector with an impact strip, according to an embodiment;

FIG. 6. is a top side view of the improved rim protector of FIG. 1, displaying a first strip end fastened to a second strip end;

FIG. 7. is a top side view of the improved rim protector of FIG. 1, displaying a fastening mechanism and a cap located on the first strip end;

FIG. 8. is a top side perspective view of the improved rim protector of FIG. 1, displaying a cap;

FIG. 9 is a perspective view of an improved rim protector, according to an embodiment, displaying an alternating insertion edge;

FIG. 10 is a perspective view of an improved rim protector, according to an embodiment, displaying an alternating insertion edge;

FIG. 11 is a perspective view of an improved rim protector, according to an embodiment, displaying a fastening mechanism;

FIG. 12. is a front perspective view of an improved rim protector installed on a wheel rim, according to an embodiment;

FIG. 13. depicts the steps of installing a rim protector apparatus, according to an embodiment; and

FIG. 14. is a perspective view of an improved rim protector installed on an automotive wheel rim, according to an embodiment.

### DETAILED DESCRIPTION OF THE EMBODIMENTS

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order more clearly to depict certain features of the invention.

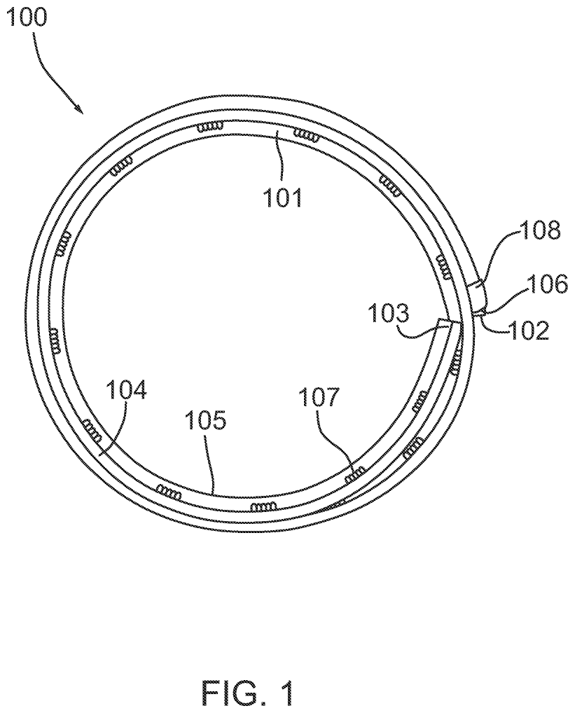

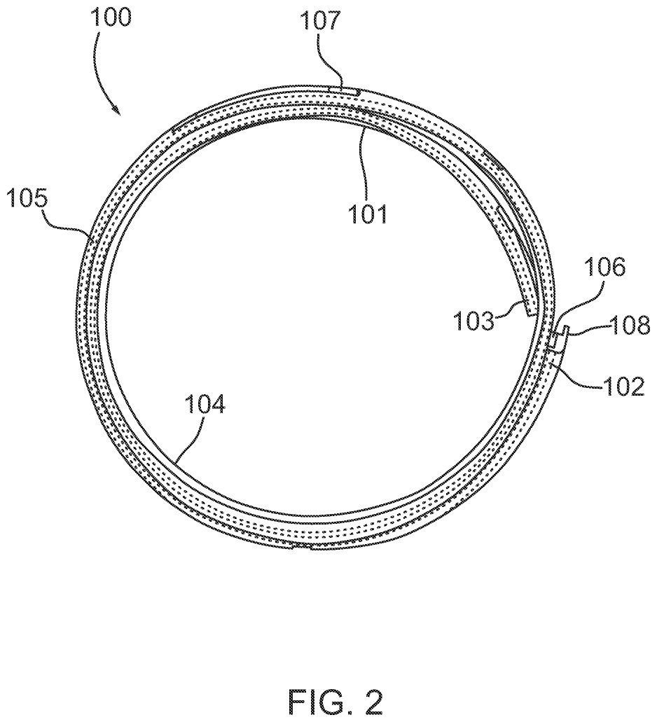

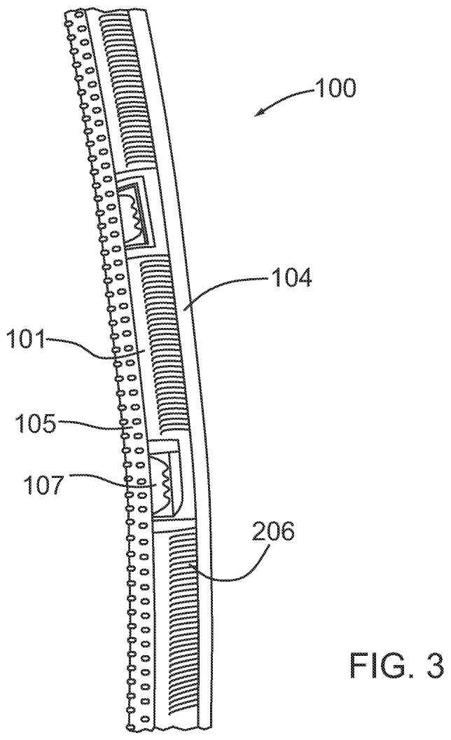

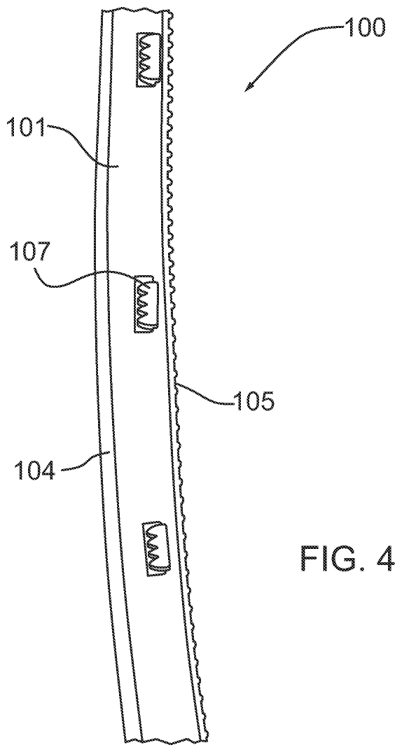

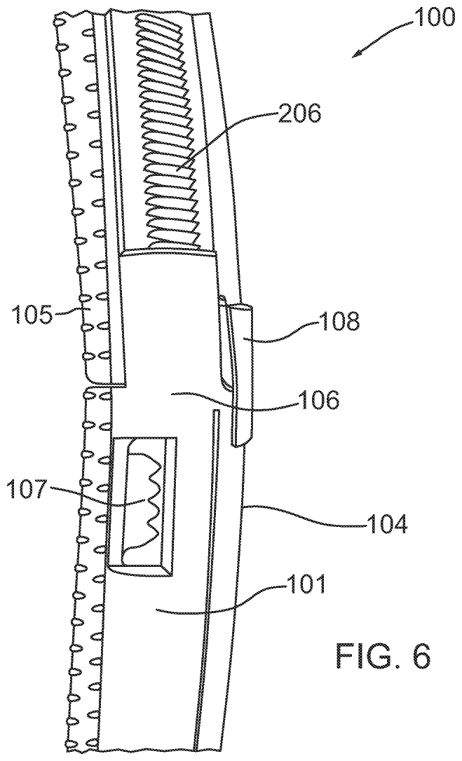

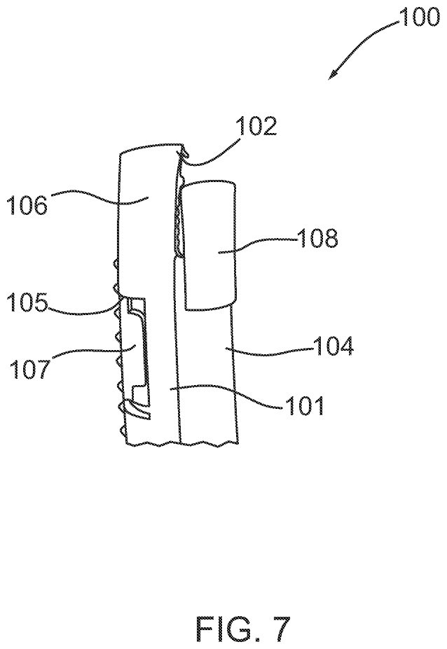

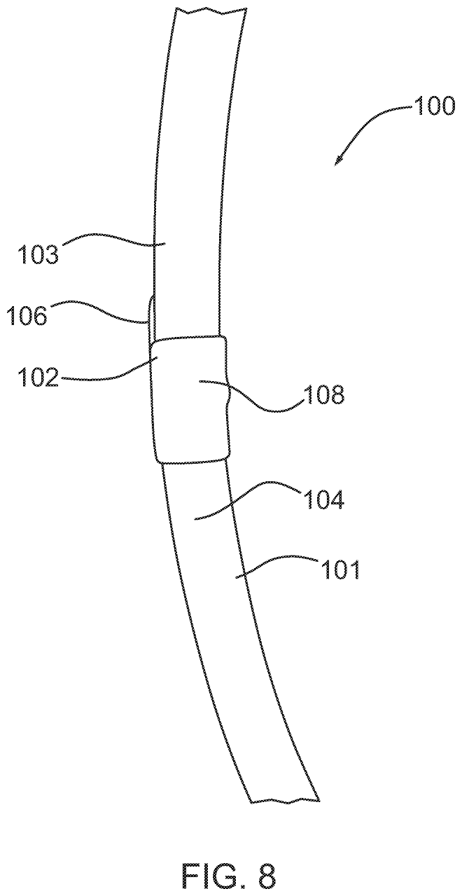

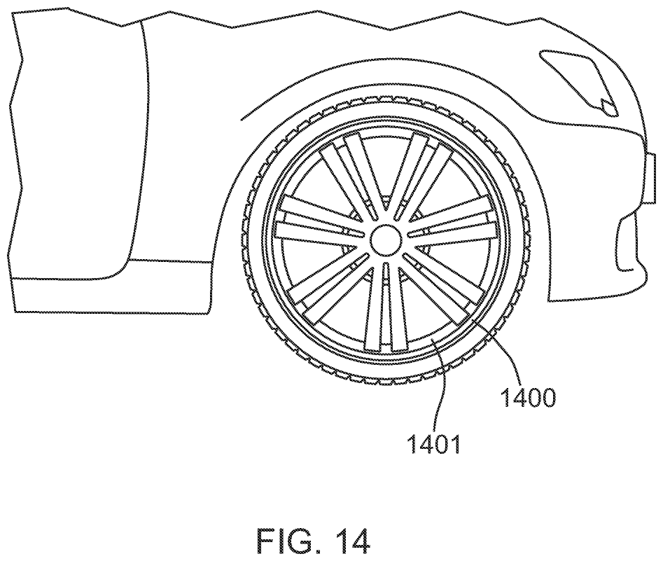

According to embodiments as shown in FIGS. 1 to 14, a rim protector for a rim of a wheel of a vehicle provides a physical barrier that absorbs impact from curbs, potholes and other poor road conditions. In use, as shown in FIGS. 12 and 14, a rim protector 1200 and 1400 is fitted to and install on a rim of a wheel of an automobile 1201 and 1401. While a rim protector for a rim of a wheel may be used to protect rims of various types of wheeled vehicles (for example, ATVs, bicycles and motorcycles), according to a preferred embodiment, a rim protector is intended for use in association with automobile wheel rims. Rim protectors may be used to prevent costly rim repairs or the need to replace a damaged rim by protecting rims from impact and to cover previous damage, such as surface level scratches. Further, rim protectors may provide a customized appearance and increase the aesthetic appeal of one's automobile by providing rim protectors in a number of popular colours. Due to its improved design, rim protectors may be easily installed, removed and re-installed, as needed, as external clips and glue are not required to secure rim protectors in place.

Rim protector 100 is comprised of a flexible strip 101. Flexible strip 101 is substantially rectangular in shape and further comprises a first strip end 102, a second strip end 103, a rim protector portion 104, an insertion edge 105, a fastening mechanism 106 and at least one set of teeth 107.

Rim protector 100 may be constructed from materials which provide sufficient strength and protection to a rim of a wheel of a vehicle from impact. According to an embodiment, rim protector 100 may be constructed of a single, moulded piece of nylon, such as high-quality impact and heat resistant PP 66 OEM grade nylon, plastic or other suitable composite materials. Manufacturing costs and desired lifespan may be considerations in informing the choice of suitable material, construction and design of rim protector 100.

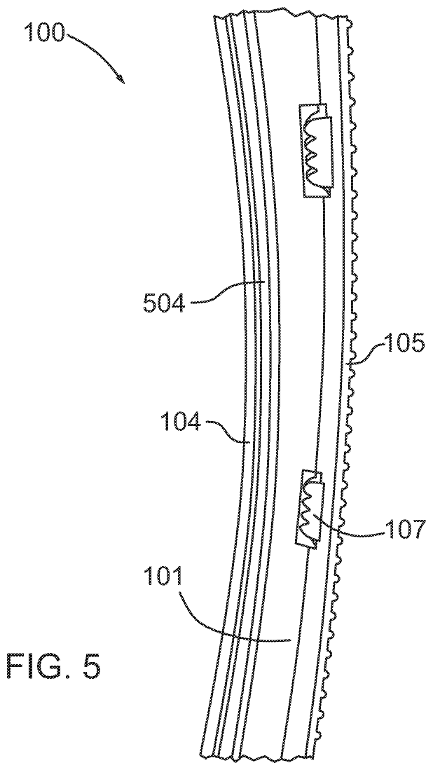

Flexible strip 101, while substantially rectangular, may be appropriately contoured to facilitate insertion between a rim of a wheel of a vehicle and a tire, as well as to protect an outer circumferential surface of a rim of a wheel from impact. Accordingly, as shown in FIGS. 1 to 8, flexible strip 101 further comprises rim protector portion 104, situated along an entire length of an outer edge of flexible strip 101 between first strip end 102 and second strip end 103. Rim protector portion 104 is designed to be seatable on a circumference of a rim of a wheel of a vehicle and to abut an outer surface of a circumference of a rim of a wheel of a vehicle, in order to provide a physical barrier between a rim and contact with road conditions. Rim protector portion 104 is further designed to leave no gap between it and an outer surface of a circumference of a rim. This prevents dirt and brake dust from accumulating under rim protector portion 104, which can damage a surface of a rim through abrasion. According to a further embodiment, as seen in FIG. 5, rim protector portion 104 may further include an impact strip 504 positioned on its underside. Impact strip 504 is designed to abut an outer surface of a rim and assists with further absorbing the impact when, for example, a rim protector hits a curb or comes into contact with a pothole.

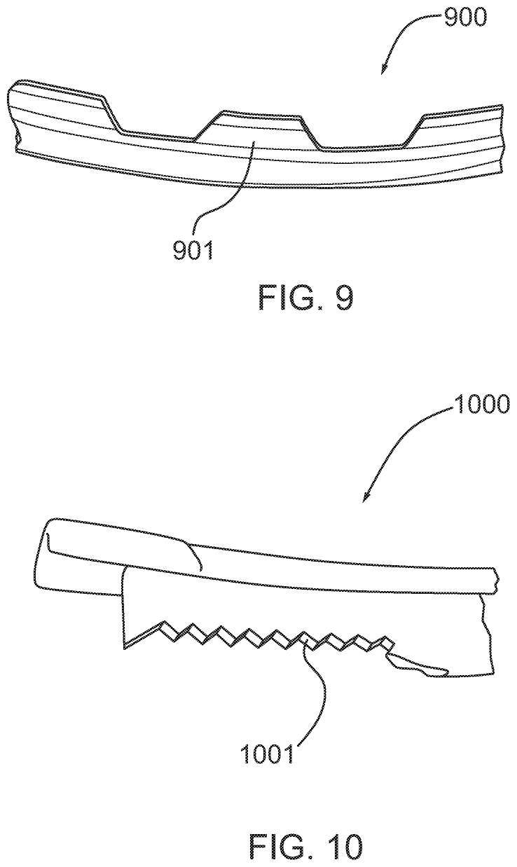

Opposite rim protector portion 104, flexible strip 101 includes an insertion edge 105. Insertion edge 105 is situated along an entire length of an outer edge of flexible strip 101 between first strip end 102 and second strip end 103. Insertion edge 105 is designed to be insertable between a rim of a wheel of a vehicle and a tire. According to a further embodiment, as shown in FIG. 9, a rim protector 900 is comprised of an alternating insertion edge 901. Alternating insertion edge may facilitate insertion of rim protector 900 between a rim and a tire, due to the decrease in surface area as compared to insertion edge 105. According to an even further embodiment, as shown in FIG. 10, a rim protector 1000 is comprised of an alternating insertion edge; however, alternating insertion edge further comprises a diamond pattern cut-out 1001 from the outer edge of the alternating insertion edge. The diamond pattern cut-out assists with further anchoring rim protector 1000 between a rim and tire by encouraging diamond pattern cut-out 1001 to engage with tread on a tire.

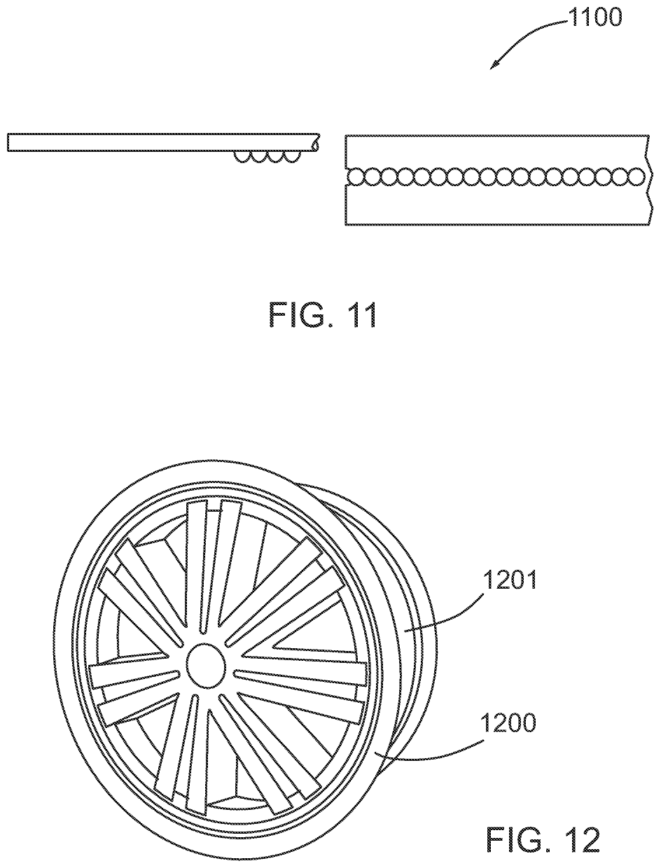

To secure first strip end 102 to second strip end 103, rim protector 100 includes a fastening mechanism 106. Fastening mechanism 106 is positioned proximate to first strip end 102 and is configured to fasten first strip end 102 to second strip end 103 in a substantially circular configuration. According to an embodiment, as shown in FIGS. 1 to 3 and 6 to 8, fastening mechanism 106 is comprised of a plurality of alternating ridges and valleys on an underside of first strip end 102 and a plurality of complimentary alternating ridges and valleys 206 on a top side of the flexible strip 101. The plurality of alternating ridges and valleys on the underside of first strip end 102 engages with plurality of complimentary alternating ridges and valleys 206 on the topside of flexible strip 101 to limit separation of first strip end 102 from second strip end 103. Fastening mechanism 106 may be particularly useful once rim protector 100 is fitted about and in use on a rim of a wheel of a vehicle, in order to resist the separation of first strip end 102 from second strip end 103 due to centrifugal forces. According to a further embodiment as shown in FIG. 11, Fastening mechanism 1100 may include a male-female snap fit engagement for a more secure attachment of a first strip end to a second strip. Further, fastening mechanism 106 may include a cap 108. According to a preferred embodiment, cap 108 and flexible strip 101 are moulded from a single piece of material. Built in cap 108 provides a perfect fit and finish to rim protector 100 that does not require the use of glue or tape when securing first strip end 102 to second strip end 103.

Rim protector 100 further includes at least one set of teeth 107 disposed along a longitudinal axis of flexible strip 101. At least one set of teeth 107 are configured to anchor insertion edge 105 between a rim of a wheel of a vehicle and a tire. According to a preferred embodiment, as shown in FIGS. 1 to 8, at least one set of teeth 107 is a plurality of set of teeth intermittently positioned along a longitudinal axis of flexible strip 101. The positioning of the plurality of at least one set of teeth 107 intermittently along the longitudinal axis of flexible strip 101 ensures that there are a number of anchoring points on rim protector 100 that can secure it about a circumference of a rim of a wheel of a vehicle. According to a preferred embodiment, at least one set of teeth 107 and flexible strip 101 may be moulded from a single piece of material, which eliminates the need to glue or tape an external set of teeth to rim protector 100.

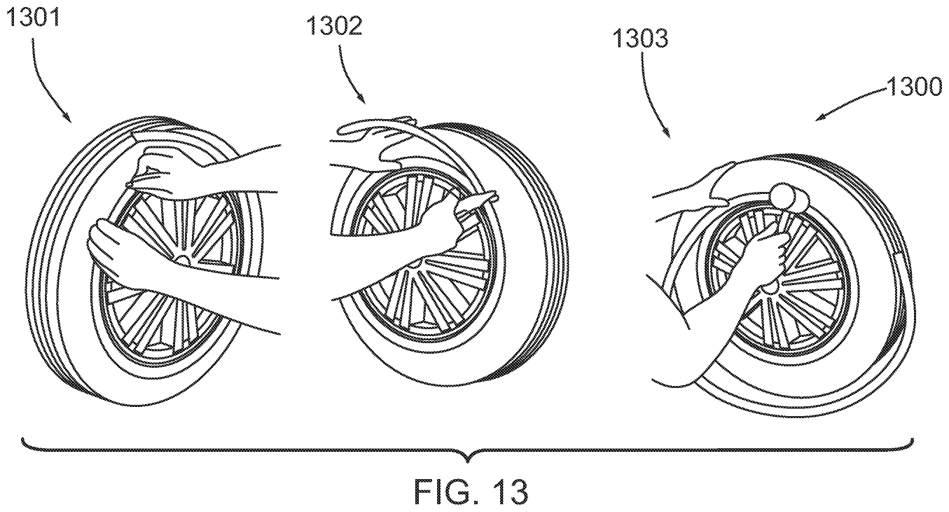

According to an embodiment, as shown in FIG. 13, when installing a rim protector about a rim of a wheel of a vehicle, the individual installing the device should first partially deflate the tire disposed about the rim. By partially deflating the tire, this creates space between the tire and the rim, in which a rim protector can be placed. Partially deflating the tire may be done while the rim of the wheel is secured to the vehicle or when the tire and rim are removed from the vehicle. Once the tire is partially deflated, an insertion edge, disposed along an outside length of a flexible strip, can be placed between the rim of the wheel of the vehicle and the tire, as seen in step 1301. At step 1301, the individual installing the rim protector may further anchor at least one set of teeth, disposed along a longitudinal axis of the flexible strip, between the rim of the wheel of the vehicle and the tire, in order to maintain the insertion edge in place. According to a further embodiment, the insertion edge may be an alternating insertion edge, similar to those depicted in FIGS. 9 and 10, which may facilitate insertion of a rim protector between a rim and a tire. Due to the decrease in surface area of alternating insertion edge 901, as compared to insertion edge 105, it may be easier to place a rim protector between a rim and a tire. Further, when rim protector 1000 is placed between a rim and a tire, diamond pattern cut-out 1001 may assist with further anchoring rim protector 1000 about the rim by encouraging diamond pattern cut-out 1001 to engage with tread on the tire. As shown in step 1302, the length of the flexible strip is customizable and may be cut to a length that substantially corresponds to a circumference of the wheel rim. When cutting the flexible strip, it is recommended to leave some additional length to ensure that the two ends of the flexible strip sufficiently overlap and can engage with one another. Once the flexible strip has been cut to size, as seen in step 1303, the individual installing the rim protector should apply a force, such as with a soft headed hammer, to a rim protector portion disposed along a length of the flexible strip opposite the insertion edge. By applying the force, such as by hammering, this causes the rim protector portion to sit on the circumference of the rim of the wheel of the vehicle and secure the insertion edge between the rim and the tire. Once the rim protector is installed, it may fastened in a substantially circular shape by attaching a first strip end to a second strip end, whereby the underside of the first strip end engages with a top side of the flexible strip by male-female engagement. Further, the tire should be reinflated to the manufacturer's optimum or recommended tire pressure for the specific make and model of the vehicle before driving the vehicle with rim protectors.

Various embodiments of the invention have been described in detail. Since changes in and or additions to the above-described best mode may be made without departing from the nature, spirit or scope of the invention, the invention is not to be limited to those details but only by the appended claims.

What is claimed is:

1. A rim protector for a rim of a wheel of a vehicle, the rim protector comprising:
a flexible strip comprising, a first strip end, a second strip end, a rim protector portion, an insertion edge, a fastening mechanism and at least one set of teeth;
the rim protector portion disposed along a length of the flexible strip between the first strip end and the second strip end and is configured to be seatable on and abut an outer surface of a circumference of a rim of a wheel of a vehicle;
the insertion edge disposed along a length of the flexible strip, opposite the rim protector portion, between the first strip end and the second strip end and is configured to be insertable between the rim of the wheel of the vehicle and a tire;
the fastening mechanism configured to fasten the first strip end to the second strip end such that the flexible strip is securable in a substantially circular configuration; and
the least one set of teeth disposed along a longitudinal axis of the flexible strip and configured to anchor the insertion edge between the rim of the wheel of the vehicle and the tire.

2. The rim protector for a rim of a wheel of a vehicle of claim 1, wherein the fastening mechanism is comprised of a plurality of alternating ridges and valleys on an underside of the first strip end and a plurality of complimentary alternating ridges and valleys on a top side of the flexible strip, whereby the underside of the first strip end engages with the top side of the flexible strip to limit separation of the first strip end from the second strip end.

3. The rim protector for a rim of a wheel of a vehicle of claim 1, wherein the fastening mechanism comprises a male-female snap fit engagement.

4. The rim protector for a rim of a wheel of a vehicle of claim 1, wherein the fastening mechanism further comprises a cap.

5. The rim protector for a rim of a wheel of a vehicle of claim 4, wherein the fastening mechanism, the cap and the flexible strip are moulded from a single piece of material.

6. The rim protector for a rim of a wheel of a vehicle of claim 1, further comprising an impact strip, wherein the impact strip is positioned on an underside of the rim protector portion which abuts the outer surface of the circumference of the rim of the wheel of the vehicle when the rim protector portion is seated on the circumference of the rim of the wheel of the vehicle.

7. The rim protector for a rim of a wheel of a vehicle of claim 1, wherein the at least one set of teeth and the flexible strip are moulded from a single piece of material.

8. The rim protector for a rim of a wheel of a vehicle of claim 1, wherein the at least one set of teeth is a plurality of sets of teeth intermittently positioned along a longitudinal axis of the flexible strip.

9. The rim protector for a rim of a wheel of a vehicle of claim 1, wherein the insertion edge is an alternating insertion edge.

10. The rim protector for a rim of a wheel of a vehicle of claim 9, wherein the alternating insertion edge further comprises a diamond pattern cut-out from the outer edge of the alternating insertion edge.

11. Use of the rim protector for a rim of a wheel of a vehicle of claim 1 to protect the rim of the wheel of the vehicle.

12. A method of installing a rim protector for a rim of a wheel of a vehicle, the method comprising:
partially deflating a tire disposed about a rim of a wheel of a vehicle;
placing an insertion edge disposed along a length of a flexible strip between the rim of the wheel of the vehicle and a tire;
cutting the flexible strip to a length that substantially corresponds to a circumference of the wheel rim; and
applying force to a rim protector portion disposed along a length of the flexible strip opposite the insertion edge to seat the rim protector portion on the circumference of the rim of the wheel of the vehicle.

13. The method of installing a rim protector for a rim of a wheel of a vehicle of claim 12, further comprising fastening a first strip end to a second strip end, whereby the underside of the first strip end fastens to the top side of the flexible strip by male-female engagement.

14. The method of installing a rim protector for a rim of a wheel of a vehicle of claim 12, wherein placing an insertion edge between the rim of the wheel of the vehicle and the tire further comprises anchoring at least one set of teeth disposed along a longitudinal axis of the flexible strip between the rim of the wheel of the vehicle and the tire.

15. The method of installing a rim protector for a rim of a wheel of a vehicle of claim 12, wherein the insertion edge is an alternating insertion edge.
